(19) United States
(12) Patent Application Publication
(10) Pub. No.: US 2012/0043768 A1
(43) Pub. Date: Feb. 23, 2012

(54) Magnetic latch assembly

(76) Inventor: Thomas Graham, Ocean, NJ (US)

(21) Appl. No.: 12/806,574

(22) Filed: Aug. 17, 2010

(51) Int. Cl. E05C 17/56

(52) U.S. Cl. 292/251.5

(57) ABSTRACT

The latch assembly has a bracket that is mounted to the side of a door and a magnetic latch that is pivotally mounted on the bracket. The latch is pivotal on a protrusion on the bracket and is held in place by a bolt passing through a washer and the bracket into the door. A second smaller protrusion on the bracket is received in an identical opening in the latch that limits the degree of pivoting of the latch relative to the bracket. Upon opening of the door, the latch is gradually “peeled” away from the magnet, i.e., pivots relative to the magnet creating a gap therebetween to reduce the pulling force necessary to open the door.

This invention relates to a magnetic latch assembly. More particularly, this invention relates to a magnetic latch assembly for a refrigerated cabinet.

As is known, various types of latching means have been provided for maintaining doors in a closed position relative to a cabinet and like structures. In some cases, the latching means have been of a magnetic type. For example, a magnetic latch assembly is known for a door that is hinged on one side and mounted on a cabinet for swinging between a closed position and an open position relative to the cabinet. The magnetic latch assembly is secured to a side of the door to cooperate with a magnet mounted in the frame of the cabinet in order to maintain the door in the closed position. The magnetic latch assembly is constructed to have a flat plate rest against the cabinet frame in a position directly opposite the magnet and be magnetically attracted by the magnet as well as a handle that can be manually grasped to pull open the door. Generally, this arrangement requires a great deal of force to pull open the door. This force cannot be decreased since the magnet might not then be sufficient to keep the door closed, particularly, on a ship where rough seas could cause the door to open.

Accordingly, it is an object of the invention to provide a magnetic latch assembly for a door that can be easily manipulated to open the door.

It is another object of the invention to provide a magnetic latch assembly that can be manipulated in a manner to facilitate opening of a door.

It is another object of the invention to significantly reduce the force required to open a magnetic latch on a door.

Briefly, the invention provides a magnetic latch assembly that can be mounted to a side of a door for magnetically locking with a magnet located at a predetermined position of a door frame and pivoted relative to the side of the door and the magnet. Typically, the door and the door frame are made of non-magnetic material, e.g. 300 series stainless steel.

Typically, the door is mounted on the door frame for movement towards and away from the frame. In this regard, the door is typically mounted in a hinged manner for a pivoting movement to bring the latch assembly opposite the magnet.

The latch of the assembly is of generally conventional structure having a first flat face for mounting on the side of the door in facing relation, a second flat face perpendicular to the first face for facing the magnet on the door frame and a curved handle extending from the first face to overlie the door on a side opposite the magnet.

In accordance with the invention, the latch assembly has a bracket that is secured to the side of the door in a stationary manner between the first flat face of the latch and the side of the door and the latch is pivotally mounted on the bracket to pivot relative to the door and relative to the magnet in response to a pulling force on the curved handle sufficient to move the door from the closed position away from the frame. In this regard, the second flat face of the latch, i.e. the face opposed to the magnet, has an edge in contact with the door frame for pivoting thereon during pivoting of the latch relative to the bracket and door.

In order to provide for pivoting of the latch, the bracket has a protrusion of circular shape and the latch includes an opening in the first flat face that receives the protrusion in mating relation for pivoting of the latch thereon. In addition, the protrusion is provided with a bore for passage of the shank of a bolt that serves to secure the bracket to the side of the door. A washer is also provided between the head of the bolt and the latch to not only cover over the opening in the latch to keep dirt and debris out to meet sanitary standards but also to hold the latch between the washer and the bracket in a slide fit manner so that the latch may be pivoted relative to the bracket while being held in place between the washer and the bracket.

In order to limit the degree of pivoting of the latch, the bracket has a second protrusion spaced from the first protrusion and the latch includes a second opening in the first flat face for receiving this second protrusion. In this respect, the second protrusion is smaller than the second opening in the latch so that the latch is able to move relative to the second protrusion during pivoting of the latch relative to the door.

As above, the second protrusion is provided with a bore for passage of the shank of a second bolt that serves to secure the bracket to the side of the door in a fixed position. In addition, as above, a second washer and a second bolt are provided to secure the latch to the door while allowing for pivoting of the latch relative to the bracket.

The latch is made of magnetically attractive material so as to be attracted by the magnet in the non-magnetic door frame so that the door may be maintained in a closed position under the magnetic forces created between the latch and the magnet.

The latch may be constructed so that the curved handle is disposed below the plane of the magnet in the cabinet frame as well as below the first flat face that pivots relative to the bracket secured to the side of the door. This increases the lever arm for a manual pulling force imposed on the latch when the door is to be opened away from the door frame.

When in use, upon closing of a door, the magnet in the cabinet attracts the flat face of the latch facing the magnet so as to pull the face into parallel alignment, and thus the latch, with the magnet.

In order to open the door, the handle of the latch is manually grasped and pulled. At this time, the latch first begins to pivot relative to the bracket in the side of the door while the uppermost edge of the latch remains in contact with the door frame and pivots thereon. During this time, the flat face of the latch facing the magnet is gradually “peeled” away from the magnet, i.e., pivots relative to the magnet creating a gap therebetween. This, in turn, reduces the magnetic attraction forces between the latch and the magnet allowing the door to be swung away from the magnet into an open position. In this way, the latch is pried at an angle to the magnet rather than being pulled straight away from the magnet. This significantly reduces the pull required to free the latch from the magnetic force.

The latch assembly may be made with a latch constructed for right-hand use or left-hand use.

The latch may also be constructed in a universal manner for right-hand use or left-hand use. In this embodiment, the latch has a pair of flat faces for selectively facing the side of a door, a second pair of flat faces facing the door frame and being angled relative to each other with only one of these flat faces having an edge in contact with the door frame as well as a pair of curved handles. Each handle is disposed opposite a respective one of the first pair of flat faces and extends over the door on a side opposite the magnet.

In this embodiment, the two flat faces that are to face the side of the door are provided with a total of three openings, only two of which are used for mounting of the latch on a bracket secured to a door. In this respect, the center opening and the upper opening are used for a right hand door while the center opening and the bottom opening are used for a left hand door.

In each case, the uppermost opening in the latch is pivotally mounted on the upper protrusion of the bracket to allow pivoting of the latch relative to the bracket. The center opening receives the other protrusion of the bracket in spaced relation to limit the pivoting movement of the latch.

These and other objects and advantages of the invention will become more apparent from the following detailed description taken in conjunction with the accompanying drawings wherein:

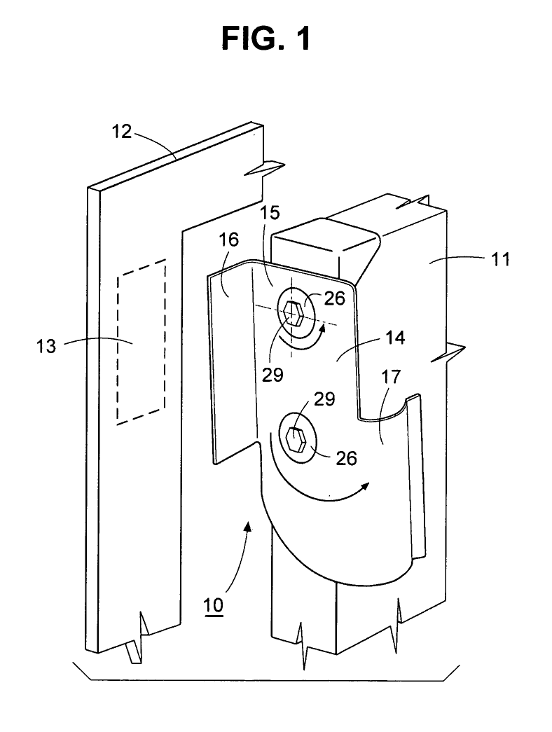

FIG. 1 illustrates a schematic view of a door mounted on a door frame with a latch assembly in accordance with the invention;

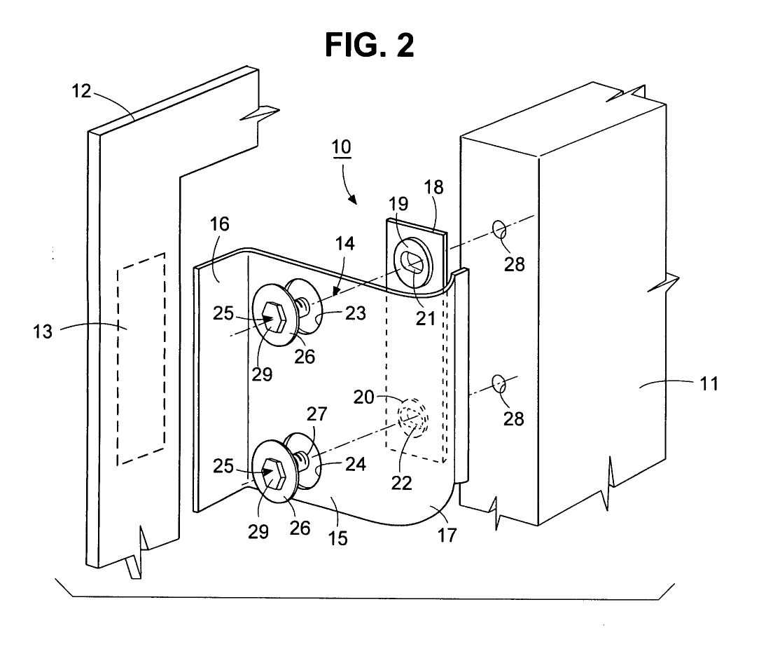

FIG. 2 illustrates an exploded view of the latch assembly of FIG. 1;

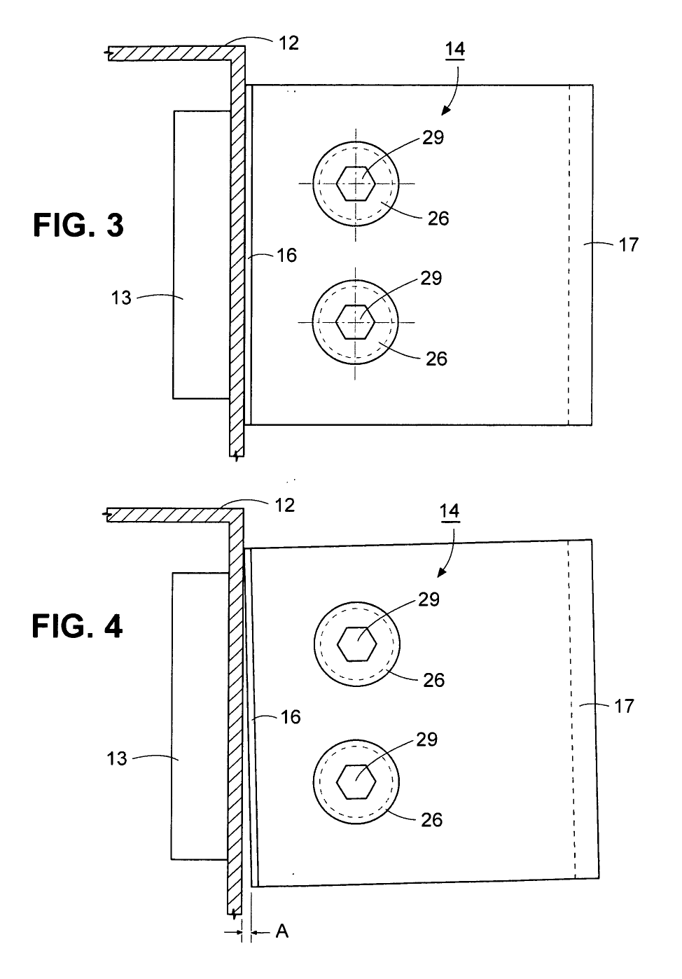

FIG. 3 illustrates a side view of the latch assembly in a closed position on a door frame;

FIG. 4 illustrates a side view of the latch assembly similar to FIG. 3 during an initial opening phase of the latch assembly relative to a door frame;

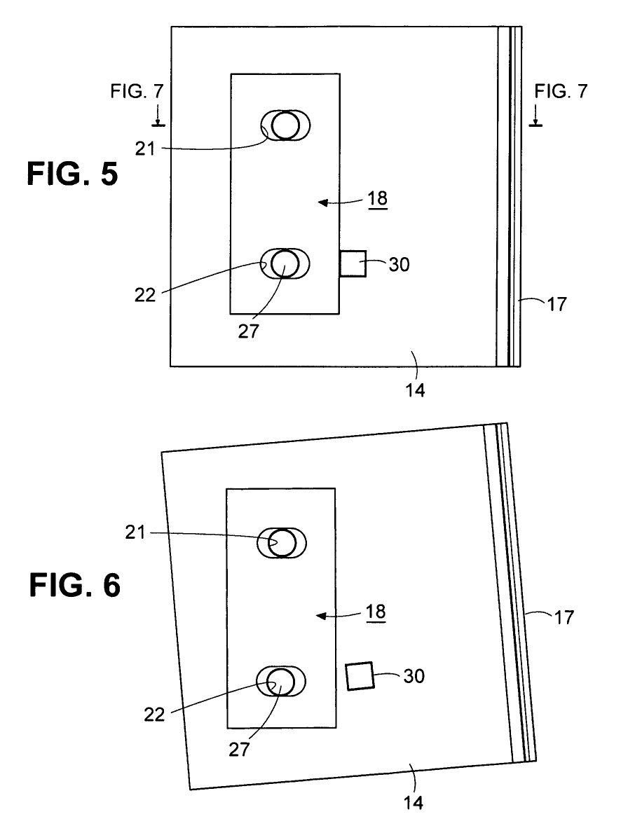

FIG. 5 illustrates a back-side view of the latch assembly in the closed position corresponding to FIG. 3;

FIG. 6 illustrates a back-side view of the latch assembly in the partially open position corresponding to FIG. 4;

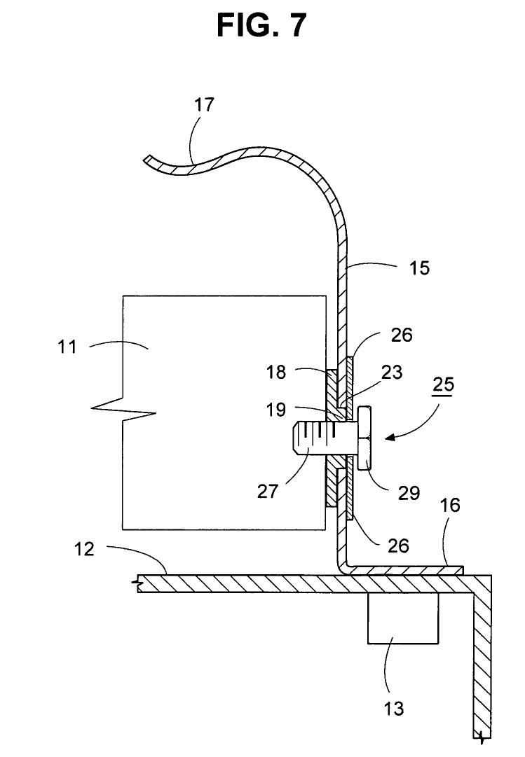

FIG. 7 illustrates a part cross-sectional view taken on line 7-7 of FIG. 5; and

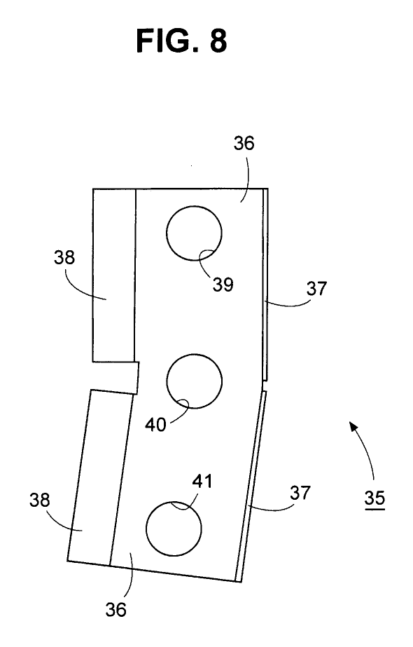

FIG. 8 illustrates a view of a latch for right-hand use or left-hand use.

Referring to FIG. 1, the latch assembly 10 is mounted on the side of a door 11 that is hinged on the opposite side to a door frame 12, for example, by two or more hinge assemblies (not shown).

The door 11 is made of a conventional structure and the door frame 12 is made of any conventional structure having a magnet 13 embedded within the structure.

The latch assembly 10 includes a latch 14 of conventional structure that has a first flat face 15 facing the side of the door 11 and a second flat face 16 perpendicular to the first flat face 15 that faces the magnet 13 in the door frame 12. At least this second flat face 16 is made of magnetic material so as to be magnetically attracted to the magnet 13 in order to maintain the door 11 in a closed position on the door frame 12.

The latch 14 also has a curved handle 17 that extends from the first flat face 14 on a side opposite the second flat face 16 to extend over the door 11 as illustrated. This handle 17 is sized so as to be manually grasped by a user so that the door 11 may be pulled from the door frame 12. The curved handle 17 is disposed below the plane of the magnet 13 in the door frame 12 as well as below the first flat face 16.

Referring to FIG. 2, the latch assembly 10 also includes a bracket 18 of rectangular shape that is adjustably secured in a stationary manner to the side of the door 11 between the latch 14 and the door 11.

The bracket 18 has a pair of circular protrusions 19, 20 facing the latch 14, each of which is provided with an elongated bore 21, 22. The protrusions 19, 20 are aligned on a common longitudinal axis of the bracket 18. In addition, the upper protrusion 19 is made with a diameter larger than the diameter of the lower protrusion 20.

The latch 14 is provided with a pair of apertures 23, 24 of identical size that are aligned with the protrusions 19, 20 of the bracket 18. The upper aperture 23, as viewed, is sized to receive the upper protrusion 19 of the bracket 18 with a small working clearance and in rotatable manner so that the latch 14 may be pivoted on the fixed bracket 18. The lower protrusion 20 of the bracket 18 is of smaller size than the lower aperture 24 of the latch 14 to accommodate pivoting of the latch 14 on the bracket 18 and to limit the degree of pivoting of the latch 14.

The latch assembly 10 also has a pair of bolts 25 and a pair of washers 26 that clamp the bracket 18 tightly to the side of the door 11 after adjustment and seat against the faces of the protrusions 19, 20 that project through the latch 14. The thickness of these protrusions 19, 20 is such that the latch 14 is retained closely but is still free to be rotated about the outer surface of the upper protrusion 19.

The washers 26 are of a size sufficient to cover over the apertures 23, 24 in the latch 14 while each bolt 25 has a shank 27 that passes through a washer 26, the latch 14 and a respective aperture 21, 22 in a protrusion 19, 20 of the bracket 18 into suitable bores 28 in the side of the door 11. Each bolt 25 has a head 29 that abuts against a washer 26 with a force sufficient to secure the bracket 18 to the side of the door 11 and yet with sufficient clearance to allow pivoting of the latch 14 relative to the bracket 18. When the latch 14 is secured to the bracket 18, the latch 14 is free to pivot about the upper protrusion 19 under a manually applied pulling force on the latch handle 17.

Referring to FIG. 3, when the latch assembly 10 is in a closed position relative to the door frame 12, the flat front face 16 is parallel to and opposite the magnet 13. Due to the magnetic attraction between the face 16 of the latch and the magnet 13, the door remains in this position.

Referring to FIG. 4, wherein like reference characters indicate like parts as above, when the handle 17 of the latch 14 is manually grasped and initially pulled, the latch 14 pivots about the axis of the upper bolt 25 and the upper protrusion 19 (see FIG. 2) of the bracket 18 (not shown) causing the bottom edge of the face 16 to pull or peel away from the door frame 12 while the upper edge of the face 16 pivots on the door frame 12 thus forming an angle A between the face 16 and the door frame 12. During this time, the magnetic force between the magnet 13 and the face 16 is sufficiently strong to allow the pivoting of the latch 14 without releasing the latch 14 from the door frame 12.

The manual pulling force required to free the latch 14 from the magnetic force of the magnet 13 is thus significantly reduced by this rotation.

The lower protrusion 20 of the bracket 18 being significantly smaller than the upper protrusion 19 and the aperture 24 permits the arcuate motion of the latch 14 but limits the motion upon contacting the rim of the aperture 24.

The slots 21, 22 in the bracket 18 may be elongated to allow for adjustment of the bracket 18 on the side of the door 11 so that the amount of compression on a rubber door gasket (not shown) can be adjusted.

Referring to FIG. 5, the back of the latch 14 is provided with an abutment 30 to position the latch 14 parallel to the door 11 and the bracket 18 at the initial adjustment.

Referring to FIGS. 5 and 7, during the final installation of the latch 17, the bolts 25 are loosely mounted to pass through the latch 17 and bracket 18 into the door 11. Thereafter, the door 11 is closed so that the force of the magnet 13 in the door frame 12 holds the face 16 of the latch 14 against the door frame 12. At this time, the magnetic force of the magnet 13 and the force of a compressed rubber door gasket (not shown) against the door 11 and, thus, against the bolts 25 and bracket 18, keep the abutment 30 on the latch 14 firmly held against the side of the bracket 18 farthest from the magnet 13 (not shown) at one “contact point” as well as moving the sidewall of the upper aperture 23 of the latch 14 into contact with the protrusion 19 on the bracket 18 at a second “contact point”. The latch 14 thus becomes parallel to the bracket 18 and to the magnet 13 on the door frame 12. The bolts 25 are then tightened to secure the latch 14 in this condition.

Thus, with the bolts 25 in a loosened state and the door 11 pushed against the frame 12 to get the proper compression of the rubber door gasket (not shown), the two points of contact, i.e., the point of contact of the larger protrusion 19 against the rightward surface of the aperture 23, as viewed in FIG. 2) and the point of contact of the rightmost edge of the bracket 18 against the abutment 30, establish the verticality of the bracket 18. The two bolts 25 are then tightened to maintain this compression and the bracket 18 remains parallel to the door 11, restrained in position by the two aforementioned points of contact, and thus keeps the latch 17 aligned parallel to the magnet in the door frame 12, without any free play, all slack being taken up by the compressive force of the gasket against the latch 12.

Referring to FIG. 6, when the door is being opened, an outward force on the latch 14 causes the latch 14 to rotate about the upper protrusion 19 (see FIG. 2). As this force is applied, the upper edge of the lever 14 pushes against the door frame 12 and angularly breaks the latch 14 free from the magnet 13 as indicated in FIG. 4. When the latch 14 has been rotated to its extreme position on the bracket 18 during opening of the door 11, the lower protrusion 20 abuts the inner surface of the aperture 24 in the latch 14, i.e. the aperture surface closest to the door frame 12, and stops further rotation of the latch 14.

Referring to FIG. 8, the latch 35 may be made for universal use or right-hand use or left-hand use. As shown, the latch 35 has a first pair of flat faces 36 for selectively facing a side of a door, a second pair of flat faces 37 for facing a door frame with one of the flat faces 37 having an edge thereof in contact with the door frame for pivoting thereon during pivoting of the latch 35 relative to the door and a pair of curved handles 38. Each handle 38 is disposed opposite a respective one of the first pair of flat faces 36 and is to extend over the door on a side opposite a magnet. A pin (not shown) may be mounted in the latch 35 for the same purpose as the protrusion 30.

As shown, the flat faces 37 for facing a magnet are angularly disposed so that only one of these faces 37 may lie against a door frame when in use.

In this embodiment, the two flat faces 36 that are to face the side of the door are provided with a total of three openings 39, 40, 41 only two of which are used for mounting of the latch 35 on a bracket 18 (not shown) secured to a door. In this respect, the center opening 40 and the upper opening 39 are used for a right hand door while the center opening 40 and the bottom opening 41 are used for a left hand door.

In each case, the uppermost opening in the latch 35 is pivotally mounted on the upper protrusion 19 of the bracket 18 (see FIG. 2) to allow pivoting of the latch 35 relative to the bracket 18. The center opening 40 receives the other protrusion 20 of the bracket 18 in spaced relation to limit the pivoting movement of the latch 35.

The invention thus provides a magnetic latch assembly for a door that can be easily manipulated to open the door and that can significantly reduce the force required to open the door.

What is claimed is:

1. In combination
a door frame having a magnet at a predetermined position;
a door mounted on said frame for movement towards and away from said frame; and
a latch mounted on said door for magnetically locking with said magnet to maintain said door in a closed position relative to said frame, said latch being pivotally secured to a side of said door to pivot relative to said door and relative to said magnet in response to a pulling force thereon sufficient to move said door from said closed position away from said frame.

2. The combination as set forth in claim 1 wherein said latch has a first flat face facing said side of said door, a second flat face facing said magnet and having an edge thereof in contact with said frame for pivoting thereon during pivoting of said latch relative to said door and a curved handle extending over said door on a side opposite said magnet.

3. The combination as set forth in claim 2 wherein said curved handle is disposed below the plane of said magnet.

4. The combination as set forth in claim 2 further comprising a bracket secured to said side of said door between said first flat face of said latch and said side of said door, said bracket having a first protrusion of circular shape and said latch including an opening in said first flat face receiving said protrusion in mating relation for pivoting of said latch thereon.

5. The combination as set forth in claim 4 further comprising a bolt having a shank passing through said opening in said latch and said protrusion into said side of said door to secure said latch to said door.

6. The combination as set forth in claim 5 further comprising a washer between a head of said bolt and said latch to cover said opening in said first flat face.

7. The combination as set forth in claim 4 wherein said bracket has a second protrusion spaced from said first protrusion and said latch includes a second opening in said flat face receiving said second protrusion and being of larger size than said second protrusion to accommodate pivoting of said latch on said bracket and to limit the degree of pivoting of said latch.

8. The combination as set forth in claim 7 further comprising a bolt having a shank passing through said second opening in said latch, said second protrusion on said bracket and into said side of said door to secure said latch to said door.

9. The combination as set forth in claim 4 wherein said first flat face has an abutment disposed in contact with said bracket in said closed position of said door to position said latch in parallel to said bracket.

10. The combination as set forth in claim 1 wherein said latch is made of magnetically attractive material.

11. The combination as set forth in claim 1 wherein said latch has a first pair of flat faces for selectively facing said side of said door, a second pair of flat faces facing said door frame with one of said second pair of flat faces having an edge thereof in contact with said frame for pivoting thereon during pivoting of said latch relative to said door and a pair of curved handles, each said handle being disposed opposite a respective one of said first pair of flat faces and extending over said door on a side opposite said magnet.

12. A magnetic latch assembly for a door comprising
a bracket for securement to the side of door, said bracket having a first protrusion of circular shape;
a latch having a first flat face abutting said bracket and including a first opening receiving said protrusion in mating relation for pivoting of said latch thereon, a second flat face perpendicular to said first flat face for facing a magnet in a door frame; and a curved handle extending from said first flat face on a side opposite said second flat face;
a washer disposed on said first flat face and over said first opening; and
a bolt having a head abutting said washer and a shank passing through said washer, said opening in said first latch and said protrusion into the side of the door to secure said latch to the door and in pivotal relation to said bracket.

13. A magnetic latch assembly as set forth in claim 12 wherein said bracket has a second protrusion and said first flat face of said latch has a second opening receiving said second protrusion and being of larger size than said second protrusion to limit the degree of pivoting of said latch.

14. A magnetic latch assembly as set forth in claim 12 wherein said bracket has a second protrusion of smaller size than said first protrusion and said first flat face of said latch has a second opening of equal size to said first opening and receiving said second protrusion therein.

15. A magnetic latch assembly as set forth in claim 12 wherein said first flat face has an abutment disposed in contact with said bracket in said closed position of said door to position said latch in parallel to said bracket.

16. A magnetic latch assembly for a door comprising
a bracket for securement to the side of door, said bracket having a first protrusion of circular shape and a second protrusion spaced from said first protrusion; and
a latch having a pair of first flat faces for selectively facing a side of a door, a pair of second flat faces for facing a door frame, a pair of curved handles, and three openings in said pair of first flat faces; each outermost opening of said three openings being sized for selective pivotal mounting on said first protrusion to allow pivoting of said latch relative to said bracket with the center opening of said three openings receiving said second protrusion in spaced relation to limit the pivoting movement of said latch.
